(19) United States
(12) Patent Application Publication
(10) Pub. No.: US 2018/0086269 A1
(43) Pub. Date: Mar. 29, 2018

(54) INTERIOR MIRROR STAY FORMED BY GAS ASSIST MOLDING PROCESS

(71) Applicant: MAGNA MIRRORS OF AMERICA, INC., Holland, MI (US)

(72) Inventors: John T. Uken, Jenison, MI (US); Christopher R. Koetje, Zeeland, MI (US); Craig Kendall, Grand Haven, MI (US)

(21) Appl. No.: 15/716,717

(22) Filed: Sep. 27, 2017

Related U.S. Application Data
(60) Provisional application No. 62/401,309, filed on Sep. 29, 2016.

(51) Int. Cl. B60R 1/04

(52) U.S. Cl. CPC B60R 1/04; G02B 7/182

(57) ABSTRACT

An interior rearview mirror assembly for a vehicle includes a mirror stay configured to attach at an in-cabin portion of a vehicle equipped with the mirror mounting system. The mirror stay is formed by injection molding a thermoplastic polymeric molding resin using a gas assist molding process. The thermoplastic polymeric molding resin includes a reinforced polyamide polymeric molding resin. A mirror head is pivotally mounted at a pivot element of the mirror stay. The mirror head includes a mirror reflective element and a mirror casing.

### CROSS REFERENCE TO RELATED APPLICATION

The present application claims the filing benefits of U.S. provisional application Ser. No. 62/401,309, filed Sep. 29, 2016, which is hereby incorporated herein by reference in its entirety.

### FIELD OF THE INVENTION

The present invention relates to interior rearview mirror assemblies for vehicles and, more particularly, to mirror stays and mounting assemblies that adjustably attach rearview mirrors to headers or windshields of vehicles.

### BACKGROUND OF THE INVENTION

It is generally known to attach a mirror stay or mount at a vehicle header or windshield for pivotally supporting an interior rearview mirror. A lower end of the mirror stay or mount pivotally attaches at a mirror head to allow for pivotal adjustment of the mirror head by the driver of the vehicle.

### SUMMARY OF THE INVENTION

The present invention provides an interior vehicle mirror stay or mount assembly that mounts a mirror or mirror head or mirror assembly at a header or a front windshield of a vehicle. The mirror stay or mount assembly includes a mounting member that has an upper portion configured to connect or attach or mount at the header or an in-cabin surface of the windshield or other interior portion of the vehicle. A lower portion of the mirror stay extends or angles from the upper portion and comprises a pivot element for pivotally attaching at a mirror head (which includes a mirror casing and mirror reflective element), such as at a socket of the mirror head. The mirror stay is formed by molding a structural plastic, such as a thermoplastic polymeric molding resin, which may include a reinforced polyamide polymeric molding resin such as Mitsubishi Reny N252A, or a glass filled PP, and/or the like, where the molding process comprises a gas-assist molding process to create a structural and hollow mirror stay having a fully class-A surface.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle having a vehicular camera and mirror mounting system in accordance with the present invention;

FIG. 2 is an exploded perspective view of a mirror assembly having an electrochromic mirror reflective element and a mirror stay formed using a gas assist molding process in accordance with the present invention;

FIG. 3 is an exploded perspective view of a mirror assembly having a prismatic mirror reflective element and a mirror stay formed using a gas assist molding process in accordance with the present invention;

FIGS. 4 and 5 are views of a known mirror stay;

FIGS. 6 and 7 are views of a mirror stay formed using a gas assist molding process in accordance with the present invention;

FIG. 8 is a sectional view of the mirror stay of FIGS. 6 and 7;

FIG. 9 is a table summarizing vibration performance testing of the mirror assemblies of FIGS. 2 and 3 with the mirror stay of FIGS. 4 and 5 and the mirror stay of FIGS. 6-8;

FIGS. 10 and 11 show test results of the mirror assembly of FIG. 2 with a baseline mirror stay;

FIGS. 12 and 13 show test results of the mirror assembly of FIG. 2 with a mirror stay formed using a gas assist molding process in accordance with the present invention;

FIGS. 14 and 15 show test results of the mirror assembly of FIG. 3 with a baseline mirror stay; and

FIGS. 16 and 17 show test results of the mirror assembly of FIG. 3 with a mirror stay formed using a gas assist molding process in accordance with the present invention.

### DESCRIPTION OF THE PREFERRED EMBODIMENTS

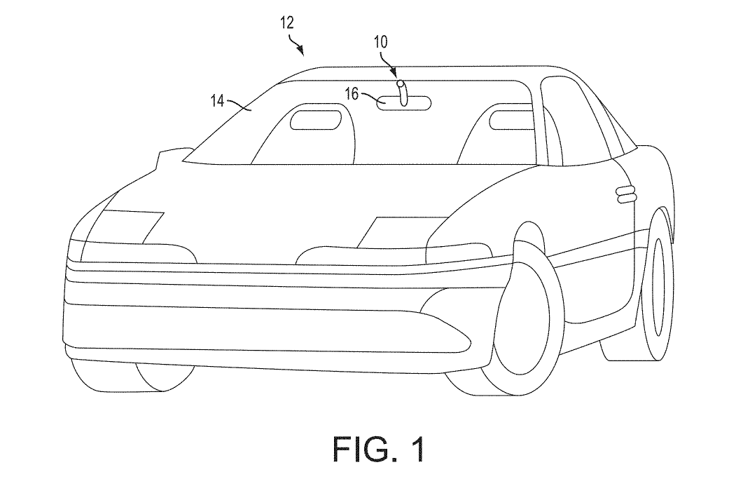

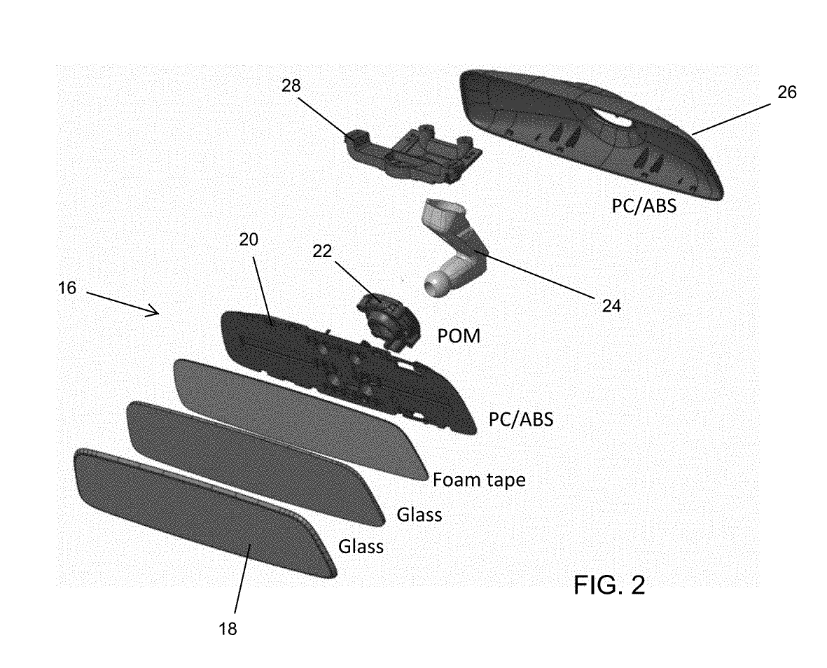

A vehicle mirror stay or mount assembly can be used to attach a rearview mirror to an interior surface of a vehicle, such as a car, truck, bus, or van. Such an interior surface may be a header, an in-cabin surface of a vehicle windshield, or other appropriate mirror mounting surface or structure. As shown in FIG. 1, a vehicle mirror mount or mount assembly 10 is configured to attach a rearview mirror 16 to a vehicle 12 at a windshield 14 of the vehicle 12. The mirror mount assembly includes a mirror stay 24 (FIGS. 2, 3 and 6-8) that is molded via a gas assist molding process to provide enhanced vibrational performance and enhanced surface characteristics, as discussed below.

The illustrated mirror mount 10 may attach to a mounting bracket or structure, such as a vehicle header or an attachment element adhesively attached at an in-cabin surface of a windshield of the vehicle, via a non-circular twist-lock attachment or via a fastener, such as a threaded screw or bolt, an adhesive, or other conceivable attachment mechanism. The mirror and mirror mount or mount assembly may utilize aspects of the assemblies, systems, and/or modules described in U.S. Publication Nos. US-2016-0355135; US-2015-0334354; US-2015-0251605 and/or US-2014-0133043, which are hereby incorporated herein by reference in their entireties. Optionally, the rearview mirror head 16 (including a mirror reflective element and mirror casing and a pivot element or mounting element) is configured to attach to a vehicle and may include a camera module, a video display behind a reflective element of the rearview mirror, a user interface, an image processor operable to process image data captured by the camera or cameras, and other electrical mirror components that may conceivably be provided in or on the rearview mirror 16. Accordingly, the mirror mount or mount assembly 10 may be provided with an electrical connector used to provide an electrical connection for such components, and further, the mirror mount 10 may be used for housing electrical wires that lead to the rearview mirror 16.

The present invention provides a Class-A cosmetic plastic single ball detachable mirror stay, which is suitable for use with a prismatic or baseline mirror assembly or mirror reflective element. For example, the mirror stay may be paired with a base or frameless or rounded perimeter edge style prismatic mirror (optionally with no electronics in the mirror head and thus no wires routed along or through the mirror stay). For example, the mirror stay may be suitable for use with mirrors of the types described in U.S. Pat. Nos. 8,508,831; 8,730,553; 7,626,749; 7,274,501; 7,255,451 and/or 7,184,190, and/or U.S. Publication Nos. US-2016-0355135; US-2015-0334354; US-2015-0251605; US-2014-0133043; US-2014-0022390; US-2014-0293169 and/or US-2015-0097955, which are hereby incorporated herein by reference in their entireties (and such as mirrors commercially available from the assignee of this application under the trade name INFINITY™ mirror).

When prismatic mirrors are specified in the car, typically there is no camera system or covers on or at the windshield. Then a two-ball or double pivot mirror mounting system is typically used. Frameless or INFINITY™ type mirrors are typically heavier than comparably sized prismatic mirrors, so vibration performance suffers with a two-ball or double pivot mounting arrangement or bracket. Also, ECE impact performance is much more consistent with a single ball because they detach during impact.

The present invention provides a fully class-A mirror stay for a prismatic mirror assembly. The process of forming the mirror stay uses a structural plastic, such as Mitsubishi Reny N252A or a glass filled PP and/or the like, and uses a gas-assist molding process to create a structural and hollow part having a fully class-A surface. Because the mirror stay has a class-A finish or surface, no additional cover or casing is needed to encase the mirror stay.

As shown in FIG. 2, the mirror 16 may comprise a generally planar glass substrate reflective element 18 (such as a reflective element having two glass substrates with an electrochromic medium sandwiched therebetween) that is adhesively attached at a mirror back plate 20, with a mounting socket or portion 22 disposed at or formed with the back plate 20. The mirror stay 24 pivotally attaches at the socket 22 and is disposed through an opening in the mirror casing 26 to attach at a mounting structure or base 28, which is typically disposed at a header region or console of the vehicle. The mirror head assembly 16 of FIG. 2 typically weighs about 250 grams.

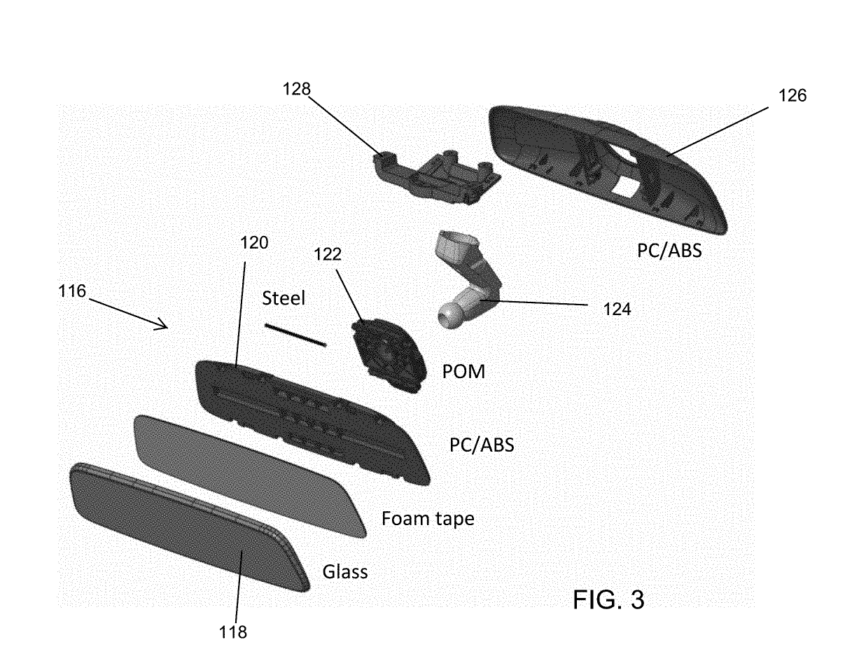

Similarly, and such as shown in FIG. 3, the mirror 116 may comprise a prismatic glass substrate reflective element 118 (such as a frameless prismatic reflective element having a glass substrate with rounded or curved perimeter edges that are exposed at and around the periphery of the mirror reflective element) that is adhesively attached at a mirror back plate 120, with a mounting socket or portion 122 disposed at or formed with the back plate 120. The mirror stay 24 pivotally attaches at the socket 122 and is disposed through an opening in the mirror casing 126 to attach at a mounting structure or base 128, which is typically disposed at a header region or console of the vehicle. The mirror head assembly 116 of FIG. 3 typically weighs about 262 grams.

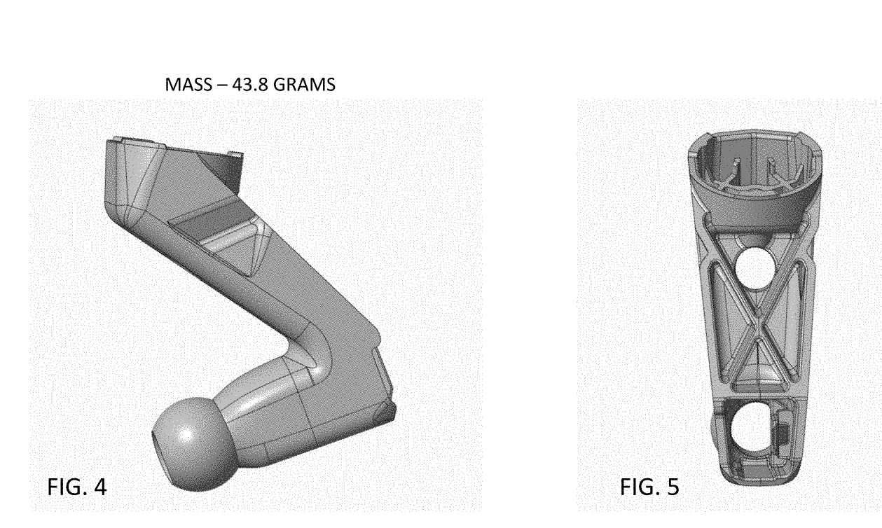

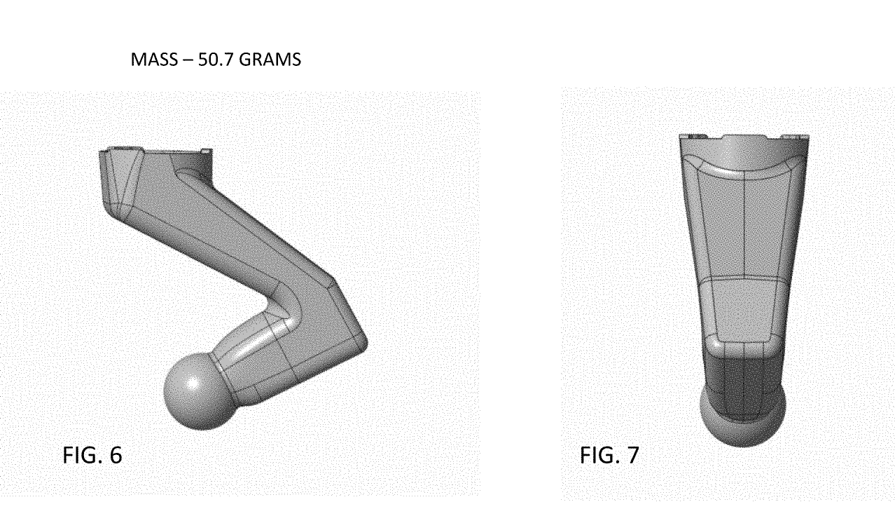

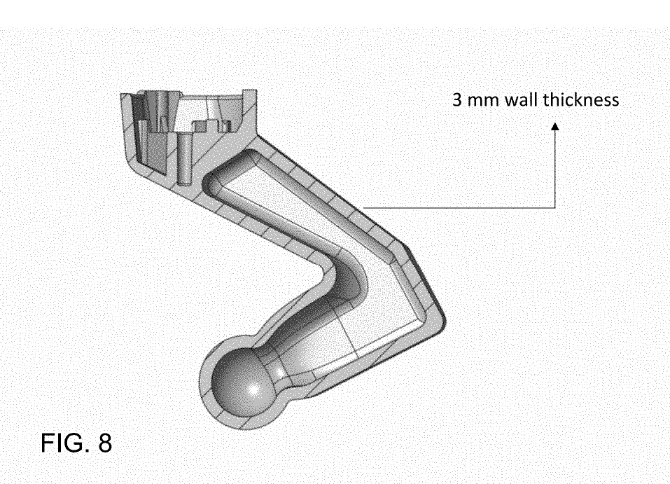

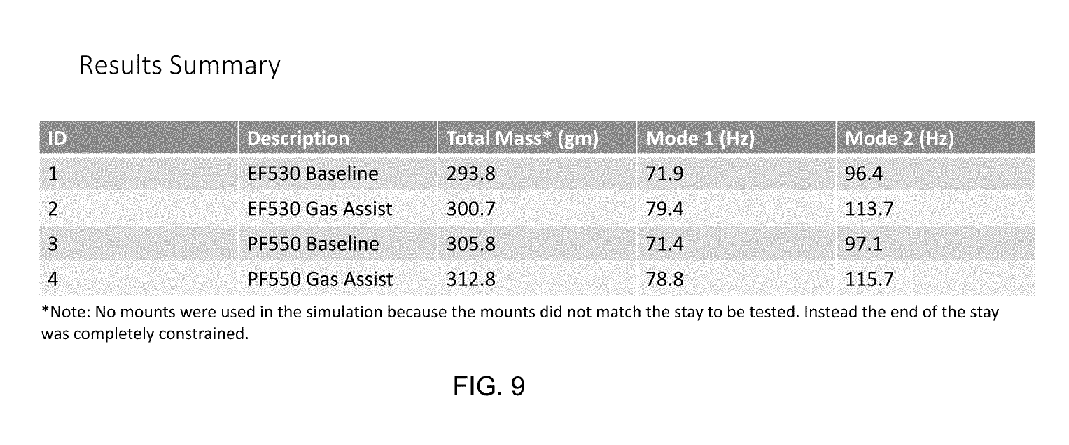

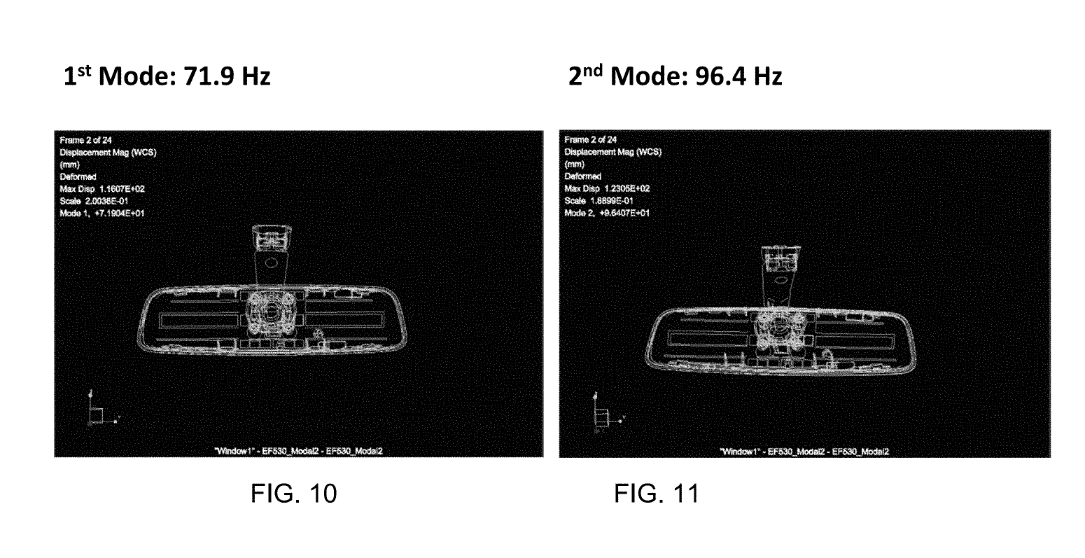

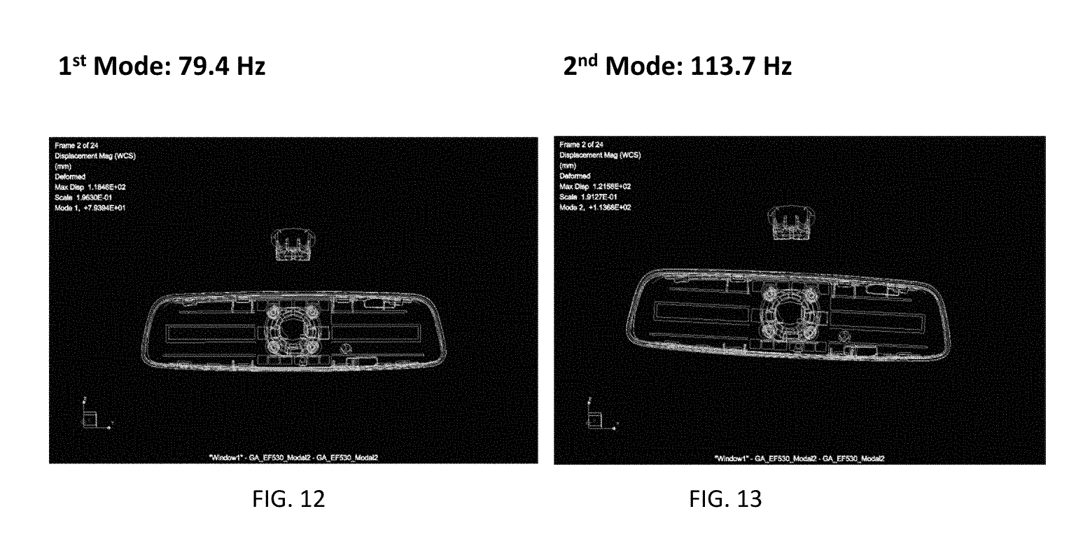

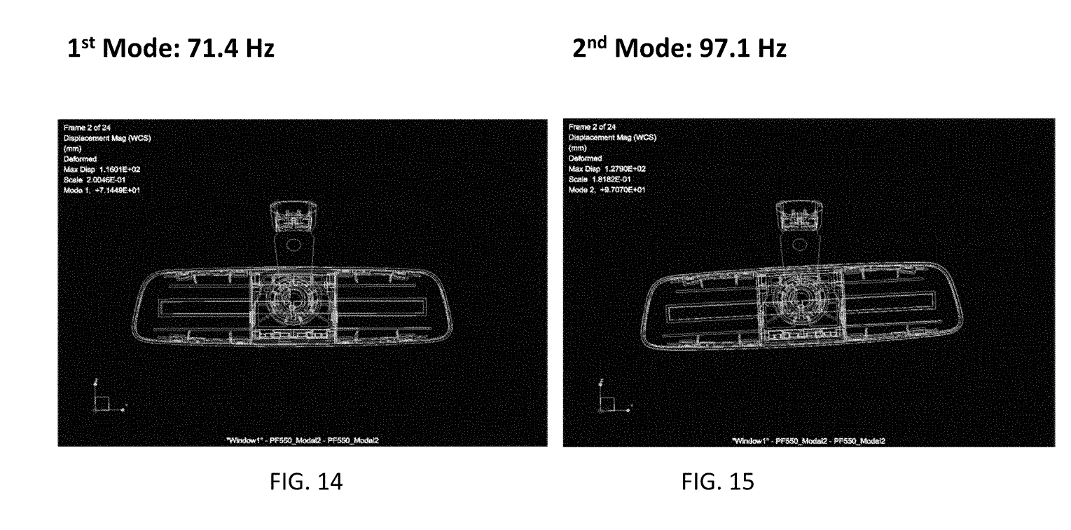

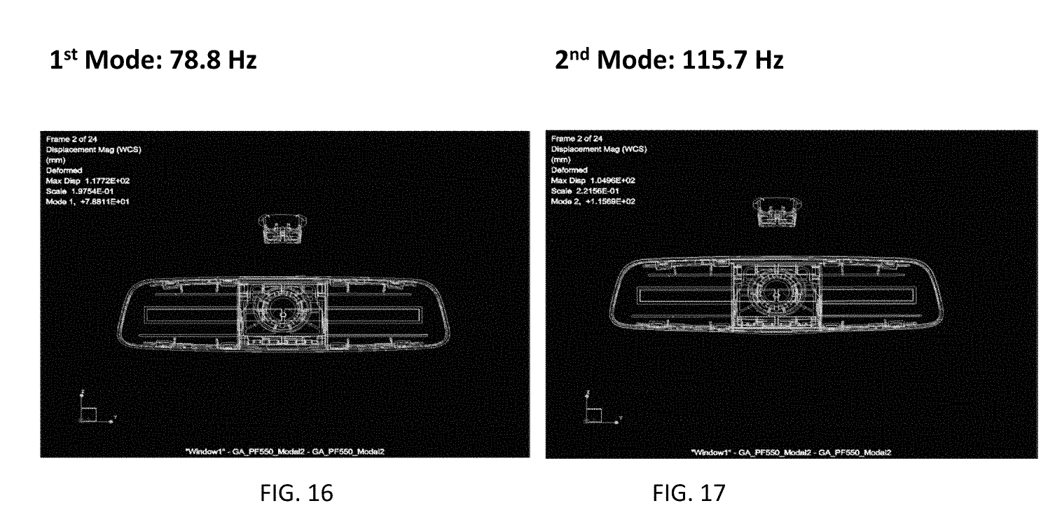

Thus, the mirror stay 24 of the present invention provides a structural support that has improved vibrational performance over conventional formed mirror stays (such as the stay shown in FIGS. 4 and 5). The baseline mirror stay of FIGS. 4 and 5 weighs about 43.8 grams, while the mirror stay 24 (see FIGS. 6-8) weighs about 50.7 grams. As shown in FIG. 8, the molded mirror stay 24 comprises a hollow part that has a wall thickness of about 3 mm (but the wall thickness could be more or less), with the injected gas (injected into the hollow cavity of the mirror stay during the molding process) providing sufficient pressure to form the walls at the desired thickness and to form the exterior surface of the mirror stay at the desired surface quality (e.g., class A surface). Thus, the mirror stay 24 may weigh a little more than a known mirror stay, but has significantly better structural support of the mirror head (and does not require an additional cover element or casing to cover or hide the mirror stay). For example, and such as shown in FIGS. 9-17, the vibration analysis shows the gas assist formed mirror stay structure creates a stronger/stiffer part than the part using standard molding processes.

The mirror stay may comprise any suitable material, such as a molded polymeric member, such as formed by injection molding of a polymeric material or resin, such as a reinforced polyamide polymeric resin, and is formed by gas-assist molding process. The preferred material for injection molding of the mirror stay according to one embodiment is RENY™ polymeric molding resin available from Mitsubishi Engineering Plastics Corporation, Japan. RENY™ comprises a thermoplastic polymeric molding compound based on mainly polyamide MXD6 that has been reinforced with glass fiber, carbon fiber and/or minerals and has generally superior mechanical strength and modulus compared with other engineering plastics so as to be suitable as a metal substitute but with lighter weight than metal. The mirror stay may be formed of other suitable polymeric materials, such as an engineering plastic or the like. Examples of suitable engineering plastics include Ultra-high-molecular-weight polyethylene (UHMWPE), Nylon 6, Nylon 6-6, Acrylonitrile butadiene styrene (ABS), Polycarbonates (PC), Polyamides (PA), Polybutylene terephthalate (PBT), Polyethylene terephthalate (PET), Polyphenylene oxide (PPO), Polysulphone (PSU), Polyetherketone (PEK), Polyetheretherketone (PEEK), Polyimides, Polyphenylene sulfide (PPS), Polyoxymethylene plastic (POM/Acetal), and/or blends/combinations thereof. Engineering plastics typically have high strength and have mechanical properties akin to those of metal. Optionally, other thermoplastic injection-moldable engineering plastics such as glass and/or mineral filled polyamides (nylon) or polycarbonate or acrylonitrile butadiene styrene (ABS) or a glass fiber polypropylene or the like can be used.

Changes and modifications to the specifically described embodiments may be carried out without departing from the principles of the present invention, which is intended to be limited only by the scope of the appended claims as interpreted according to the principles of patent law.

1. An interior rearview mirror assembly for a vehicle, said interior rearview mirror assembly comprising:
a mirror stay configured to attach at an in-cabin portion of a vehicle equipped with said mirror mounting system;
wherein said mirror stay is formed by injection molding a thermoplastic polymeric molding resin using a gas assist molding process, said thermoplastic polymeric molding resin comprising a reinforced polyamide polymeric molding resin; and
a mirror head pivotally mounted at a pivot element of said mirror stay, said mirror head comprising a mirror reflective element and a mirror casing.

2. The interior rearview mirror assembly of claim 1, wherein said mirror stay comprises a mounting portion configured to mount the mirror stay at the in-cabin portion of the equipped vehicle, a pivot element that is configured to pivotally mount the mirror reflective element, and an arm disposed between the mounting portion and the pivot element.

3. The interior rearview mirror assembly of claim 2, wherein said pivot element comprises a ball member that is configured to be pivotally received in a socket at the rear of the mirror reflective element.

4. The interior rearview mirror assembly of claim 2, wherein said arm and said pivot element are hollow.

5. The interior rearview mirror assembly of claim 2, wherein said mirror reflective element comprises a prismatic reflective element.

6. The interior rearview mirror assembly of claim 5, wherein said prismatic reflective element comprises a frameless prismatic reflective element.

7. The interior rearview mirror assembly of claim 1, wherein said reinforced polyamide polymeric molding resin comprises a thermoplastic glass fiber reinforced polyamide polymeric molding resin.

8. The interior rearview mirror assembly of claim 1, wherein said reinforced polyamide polymeric molding resin comprises a thermoplastic carbon fiber reinforced polyamide polymeric molding resin.

9. The interior rearview mirror assembly of claim 1, wherein said reinforced polyamide polymeric molding resin comprises a thermoplastic mineral reinforced polyamide polymeric molding resin.

10. The interior rearview mirror assembly of claim 1, wherein said reinforced polyamide polymeric molding resin comprises RENY™ polymeric molding resin.

11. A method of forming a mirror stay for the interior rearview mirror assembly, said method comprising:
injection molding a mirror stay that is configured to attach at an in-cabin portion of a vehicle equipped with a mirror mounting system;
wherein injection molding the mirror stay comprises injection molding a thermoplastic polymeric molding resin using a gas assist molding process; and
wherein the thermoplastic polymeric molding resin comprises a reinforced polyamide polymeric molding resin.

12. The method of claim 11, wherein the reinforced polyamide polymeric molding resin comprises a thermoplastic glass fiber reinforced polyamide polymeric molding resin.

13. The method of claim 11, wherein the reinforced polyamide polymeric molding resin comprises a thermoplastic carbon fiber reinforced polyamide polymeric molding resin.

14. The method of claim 11, wherein the reinforced polyamide polymeric molding resin comprises a thermoplastic mineral reinforced polyamide polymeric molding resin.

15. The method of claim 11, wherein the reinforced polyamide polymeric molding resin comprises RENY™ polymeric molding resin.

16. A method of forming a mirror stay for the interior rearview mirror assembly, said method comprising:
injection molding a mirror stay that is configured to attach at an in-cabin portion of a vehicle equipped with a mirror mounting system;
wherein injection molding the mirror stay comprises injection molding a thermoplastic polymeric molding resin using a gas assist molding process;
wherein the thermoplastic polymeric molding resin comprises a reinforced polyamide polymeric molding resin;
wherein injection molding the mirror stay comprises injection molding a mounting portion configured to mount the mirror stay at the in-cabin portion of the equipped vehicle, a pivot element that is configured to pivotally mount the mirror reflective element, and an arm disposed between the mounting portion and the pivot element;
wherein the pivot element comprises a ball member that is configured to be pivotally received in a socket at the rear of the mirror reflective element; and
wherein injection molding the mirror stay comprises injection molding the mirror stay such that the arm and the ball member are hollow.

17. The method of claim 16, wherein the reinforced polyamide polymeric molding resin comprises a thermoplastic glass fiber reinforced polyamide polymeric molding resin.

18. The method of claim 16, wherein the reinforced polyamide polymeric molding resin comprises a thermoplastic carbon fiber reinforced polyamide polymeric molding resin.

19. The method of claim 16, wherein the reinforced polyamide polymeric molding resin comprises a thermoplastic mineral reinforced polyamide polymeric molding resin.

20. The method of claim 16, wherein the reinforced polyamide polymeric molding resin comprises RENY™ polymeric molding resin.
